(19) United States
(12) Patent Application Publication
(10) Pub. No.: US 2011/0015945 A1
(43) Pub. Date: Jan. 20, 2011

(54) BIOMETRIC MEDICATION ADMINISTRATION SYSTEM AND METHOD

(75) Inventor: Ken Addy, Massapequa, NY (US)

Correspondence Address: HONEYWELL/HISCOCK;Patent Services, 101 Columbia Road, P.O. Box 2245, Morristown, NJ, 07962-2245, US

(73) Assignee: Hand Held Products, Inc., Skaneateles Falls, NY (US)

(21) Appl. No.: 12/504,950

(22) Filed: Jul. 17, 2009

(51) Int. Cl. G06Q 50/00; G06F 17/30; H04B 7/00; G06K 19/00; G06K 9/00

(52) U.S. Cl. 705/3; 705/2; 455/41.3; 235/487; 382/117; 707/E17.108; 707/E17.044

(57) ABSTRACT

A method of accurately administering medication to a patient includes enrolling the patient including capturing an enrollment iris image, converting the enrollment iris image into an enrollment iris code, and associating the enrollment iris code with the patient, associating a medication with a patient including associating a medication bar code value associated with the medication bar code with the patient, administering a medication to the patient including capturing a current iris image, converting the current iris image into a current iris code, capturing a current medication bar code image of the bar code associated with the medication, converting the current medication bar code image into a current medication bar code value, querying the database for any patient having a previously stored enrollment iris code matching the current iris code and comparing each previously stored medication bar code value associated with the patient with the current medication bar code value.

### TECHNICAL FIELD

The present invention relates to authentication and verification systems utilizing biometric input, and more specifically, to a system and method of utilizing iris recognition to accurately administer medication to a patient.

### BACKGROUND INFORMATION

Hospitals and other medical facilities dispense large numbers of prescription and over the counter drugs, medications, vaccines and other biological products. This dispensing process is a significant source of inaccuracy due to medication errors including the administration of medication to the wrong patient often resulting in severely adverse patient reactions. Since medical facility pharmacies dispense millions of medication doses annually, even a small error rate is significant when consideration is given to the extremely harmful potential implications of such an error.

Due at least partially to recently issued FDA regulation requirements and motivated by an attempt to alleviate identification and medication error rates, medical facilities have implemented a process of attaching bar codes to most prescription and over the counter drugs. Medical facilities have long distributed a wristband containing a bar code to each patient upon enrollment or registration as a patient in the facility. Since both the wristband and the medication contain a bar code identifying the patient, a system of scanning each bar code to determine a patient match developed and has been universally used in the process of dispensing medication.

However, the bar code system, and specifically the wristband element, has significant potential for error which has rendered the wristband bar code solution inadequate. For example, errors have arisen due to workarounds taken by health care professionals (Koppel R, et al “Workarounds to barcode medication administration systems: their occurrences, causes, and threats to patient safety.” J. Am. Med. Inform. Assoc. 2008; 15: 408-423) including removing the wristband bar code and affixing it instead to the nursing station, computers-on-wheels (COWs), supply room, patient's room door jam, medication dispensing machine, medical professional's clipboard, the scanner itself, and on the medical professional's sleeve, belt or pocket, overriding due to frustration with readability of bar code due to scanning technique, uncertainty as to scan effectiveness, or uncertainty as to audible nature of verification alarm and refusing to scan due to the scanner being tethered to a COW which will not fit in patient's room or the scanning equipment being too bulky to transport to a supply room or refrigerator. In addition to medical professional workarounds, bar codes on wristbands present the potential for a number of other errors due to the bar code being unreadable because it is cut, smudged, chewed, deteriorated by fluids, inaccessible because it was never provided, was previously removed, or is covered with sterile dressing or blankets, invalid due to it being from a prior hospital admission or inaccurate because it was incorrectly assigned.

In addition to violating the right person and right medication patient rights, other sources of error in medical facilities include administering medication at the wrong time or at the wrong frequency, of the wrong dose, to a patient having the wrong blood type, and through the wrong means, for example.

Accordingly, there is a need in the art for a substantially accurate system and method that reduces the possibility for error in the process of administering medication in a medical facility while being highly portable and/or handheld and easy to use for a health care professional.

### BRIEF DESCRIPTION OF THE DRAWINGS

These and other features and advantages will be better understood by reading the following detailed description, taken together with the drawings wherein:

FIG. 1 is a block schematic diagram of an exemplary biometric medication administration system in accordance with the present invention.

FIG. 2 is a front plan view of an exemplary biometric medication administration system in accordance with the present invention.

FIG. 3 is a block diagram depicting the principal steps of the process of enrolling a patient in accordance with the present invention.

FIG. 4 is a block diagram depicting the principal steps of the process of associating a medication with a patient in accordance with the present invention.

FIG. 5 is a block diagram depicting the principal steps of the process of administering a medication to a patient in accordance with the present invention.

### DETAILED DESCRIPTION

Recognition, verification and authentication systems and methods have long used physiological biometrics such as fingerprint recognition, facial recognition, iris recognition, vascular recognition, hand/palm geometry, DNA, and retina recognition among many others. Each of these methods has various advantages and disadvantages as well as error rates. Because it is widely believed that iris recognition is among the most accurate biometric parameters with significantly reduced error rate due to the iris being unique for each individual, having a highly detailed pattern, and being stable over many years beginning at a very young age (less than 24 months of development) and because the iris is typically highly accessible to medical facility personnel, among other reasons, the following specification describes one embodiment of the present invention which utilizes iris recognition as the biometric parameter. However, it should be noted that any biometric capable of being obtained using a 2D imager and decoding program instructions can replace iris recognition as the biometric used in the biometric medication administration system and method of the present invention.

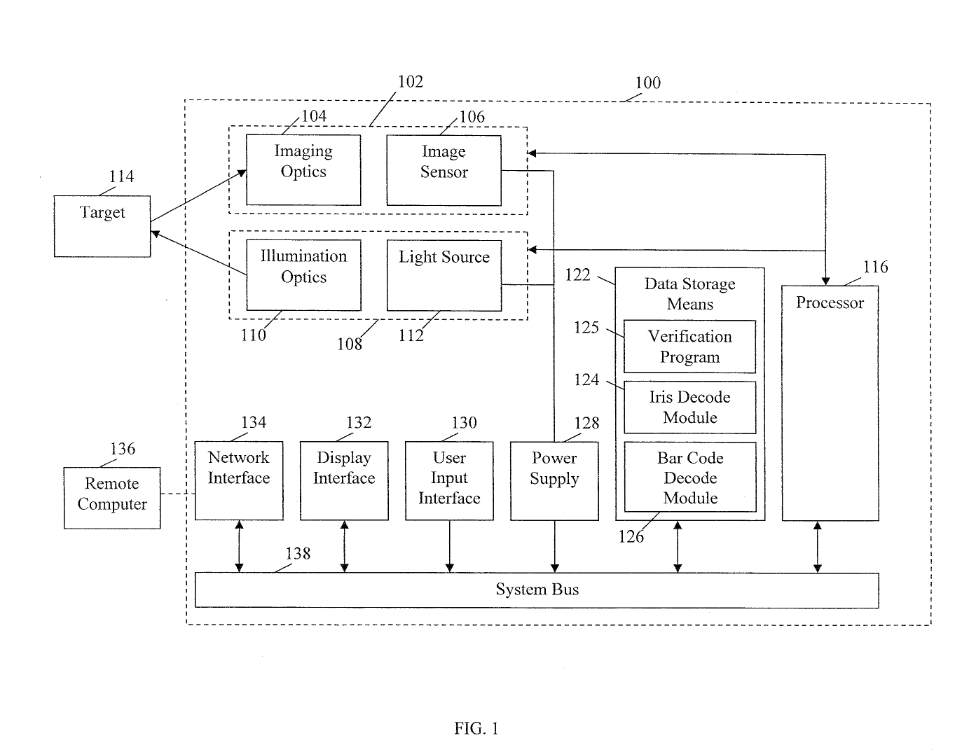

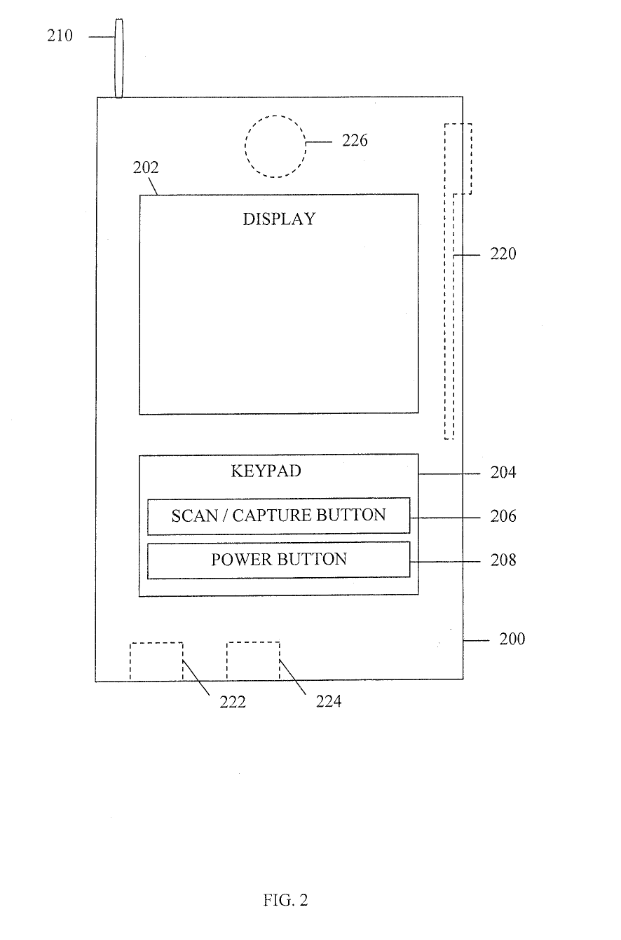

Referring to FIGS. 1-2, there is shown a block diagram of the basic structures that together comprise an optical reader 100 that is suitable for use in a biometric medication administration system. The optical reader 100 includes an illumination assembly 108 for illuminating a target 114, such as a bar code, a human iris, or any other object, and an imaging assembly 102 for receiving an image of the target 114 and generating an electric output signal indicative of the data optically encoded therein. The illumination assembly 108 includes at least one light source 112, such as one or more LEDs, together with illuminating optics 110, such as one or more reflectors, for directing light from the light source in the direction of the target 114. In a preferred embodiment, the light source 112 includes at least one LED configured to emit light in the near-infrared range and at least one LED configured to emit light in the visible range. The imaging assembly 102 includes a 2D image sensor 106, such as a CCD, CMOS, NMOS, PMOS, CID, or CMD solid state imagine sensor, along with imaging optics 102 for receiving and focusing an image of the target 114 onto the image sensor 106.

The optical reader 100 also includes one or more programmable control means such as a processor 116 and/or a microprocessor such as a VLSI integrated circuit microprocessor. The processor 116 is configured to receive, output and process data, including image/pixel data, in accordance with instructions stored in a data storage means 122 such as a local, network-accessible, removable and/or non-removable memory, such as RAM, ROM, and/or flash, operate the imaging 102 and illumination assemblies 108, and communicate with a system bus 138 among other operations. More specifically, the processor 116 may be configured to control the illumination of the at least one light source 112, the timing of the image sensor 106, analog-to-digital conversion, transmission and reception of data to and from a processor of a remote computer 136 external to the reader through a network interface 134, such as an RS-232, RS-485, USB, Ethernet, Wi-Fi, Bluetooth, IrDA and/or Zigbee interface, and control an output device 202, such as an LCD or an OLED display, through the display interface 132. Even more specifically, in a preferred embodiment as noted above, the processor is configured to control the illumination of the at least one light source 112 such that when implementing program instructions including the capture of an iris image, as discussed below, at least one near-infrared LED is engaged in order to allow for increased quality and reliability of the imaging of dark irises. Similarly, in the preferred embodiment, the processor is configured to control the illumination of the at least one light source 112 such that when implementing program instructions including the capture of a bar code image, as discussed below, at least one visible light LED is engaged. Alternatively, in another embodiment, at least one visible light LED is engaged by the processor during both iris and bar code image capture. In yet another embodiment, the processor can be configured to control the iris image capture process such that successive iris images are captured, stored, and used in the enrollment and/or administration processes, as fully described below, wherein one iris image is captured using near-infrared light and one iris image is captured using visible light. The optical reader 100 also includes one or more power supplies 128, such as one or more batteries and/or circuitry for receiving an alternating current, and a user input interface 130 for receiving data from a user input device 204, such as a keyboard, keypad, and/or touch screen. The optical reader 100 structures shown in FIG. 1 are preferably supported on one or more printed circuit boards (not shown).

The one or more printed circuit boards are supported within a housing 200 such as the housing 200 shown in FIG. 2. The housing 200 can be shaped so as to fit comfortably into a human hand and can include a finger actuatable scan/capture or trigger button 206 as well as a keypad 204 for inputting data and commands to the processor 116, power button 208, and antenna 210 for facilitating communication with a local or remote host processor, for example. The housing 200 also includes a display 202 for displaying information to the user. If the display 202 is a touch screen, a stylus 220 may also be included to facilitate interaction with the touch screen. An aperture 226 in the housing is included such that the illumination 108 and imaging optics 102 have significantly unobstructed access to the target 114. The housing 200 can also include a power port 222 for receiving a power supply as well as one or more communication ports 224 for facilitating communication with a network interface 134.

Referring again to FIG. 1, the data storage means 122, such as memory as discussed above, includes an iris decode module 124 including a set of program instructions that, when implemented by the processor 116, convert an image to an iris code. More specifically, the iris decode module 124 contains program instructions that, when implemented by the processor 116, find the iris in the image and convert the iris portion of the image to an iris code as is known in the art and is taught, for example, by U.S. Pat. No. 5,291,560 which is incorporated herein by reference. The data storage means also includes a bar code decode module 126 including a set of program instructions that, when implemented by the processor 116, convert an image to a bar code value. The bar code can be a 1D, 2D, 1D stacked or 2D stacked bar code of any type of symbology such as PDF417, Aztec, QR Code, Vericode and the like. More specifically, the bar code decode module 126 contains program instructions that, when implemented by the processor 116, find the bar code in the image and convert the bar code portion of the image to a bar code value as is well known in the art and is taught, for example, in U.S. Pat. Nos. 7,059,525 and 7,398,929 which are incorporated herein by reference. The processor 116 retrieves program instructions from the iris decode module 124 or the bar code decode module 126 depending on the instruction received from the user through the user interface device 204 as discussed in more detail below.

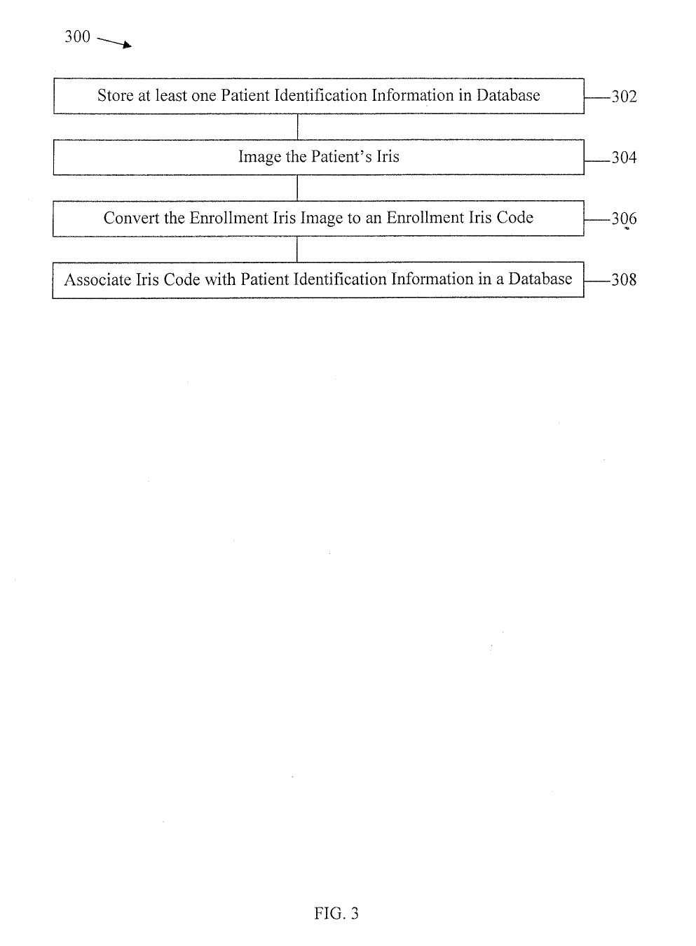

The overall operation of the system will now be described with respect to the method steps shown in FIGS. 3-5. The overall process involves enrolling a patient of a medical facility in order to create a record of the patient's iris code optionally in combination with other identifying information, preparing a medication to contain a bar code having a bar code value associated with the patient, and administering the medication to the patient by capturing an image of the patient's iris, decoding the image to determine the patient's iris code, capturing an image of the medication bar code, decoding the image to determine the bar code value, and communicating to the health care professional whether there is a match such that the patient is the intended recipient of the medication.

Referring to FIG. 3, a block diagram depicting the principal steps of the process of enrolling a patient 300 is shown. When a person initially enters a medical facility in anticipation of treatment, a record containing personal identification of the patient such as name, phone number, date of birth, social security number, blood type, and health care insurance provider, among others, is optionally created in a database at step 302. Next, an image is captured of the patient's iris at step 304 and the enrollment iris image is decoded to determine an enrollment iris code at step 306. Any number of known devices can be used to capture the enrollment iris image of the patient's iris. In one embodiment, a conventional iris recognition device such as the IrisAccess™ iCam4000/4100 by LG Electronics Inc., PIER™ 2.4 by L-1 Identity Solutions, Inc., or the IRISPASS™ by OKI Electric Industry Corporation is used to capture an enrollment iris image and decode the enrollment iris image to determine an enrollment iris code.

However, preferably, the same program instructions used by the enrollment device to determine an iris code from an iris image 306 are stored in the iris decode module 124 of the biometric medication administration system described above so as to increase the stability of iris image decoding thereby reducing error rates and false negative indications. Accordingly, in another embodiment, the biometric medication administration system described above can also be used for patient enrollment. In this embodiment, the data storage means 122 described above further contains an enrollment module having program instructions that, when implemented by the processor 116, facilitate user interaction with the system to capture an enrollment iris image and convert the enrollment iris image to an enrollment iris code 306.

In one embodiment, once the enrollment iris code is determined at step 306, it is stored in a database 308 in association with the patient identification information stored previously in step 302. Accordingly, the database contains a record having patient information such as the patient's name. When an iris code is determined in step 306, the iris code is stored as being associated with the patient's name in the record 308.

In another embodiment, step 304 and step 306 occur in that order but prior to step 302 such that an image of the patient's iris is captured and decoded prior to patient identification information being stored in a database. In this embodiment, the patient's iris code is stored in a database and, subsequently, the patient's identification information is stored as being associated with the patient's iris code.

In yet another embodiment step 302 is eliminated and no patient identification information is stored in the database. However, in this embodiment, preparing medication including associating a medication bar code value with a patient in the database requires knowledge of the patient's enrollment iris code instead of other identification information such as the patient's name or social security number.

In one embodiment, the database is a relational database and the patient is represented by one tuple or record of a table. In this embodiment, the patient's name, for example, and the patient's iris code are attributes or fields associated with the record representing the patient.

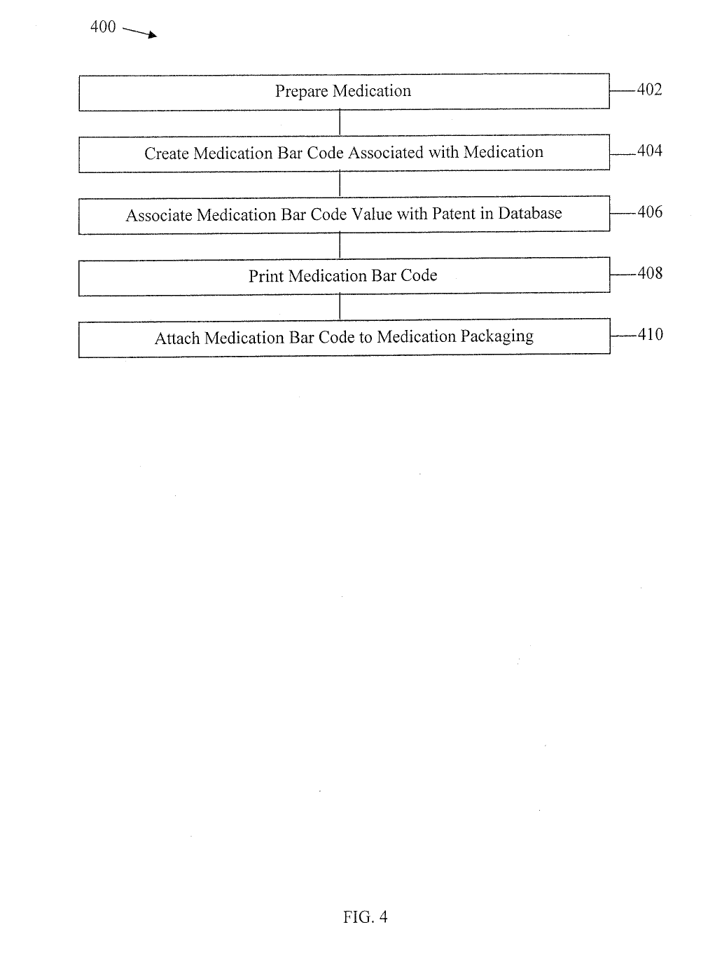

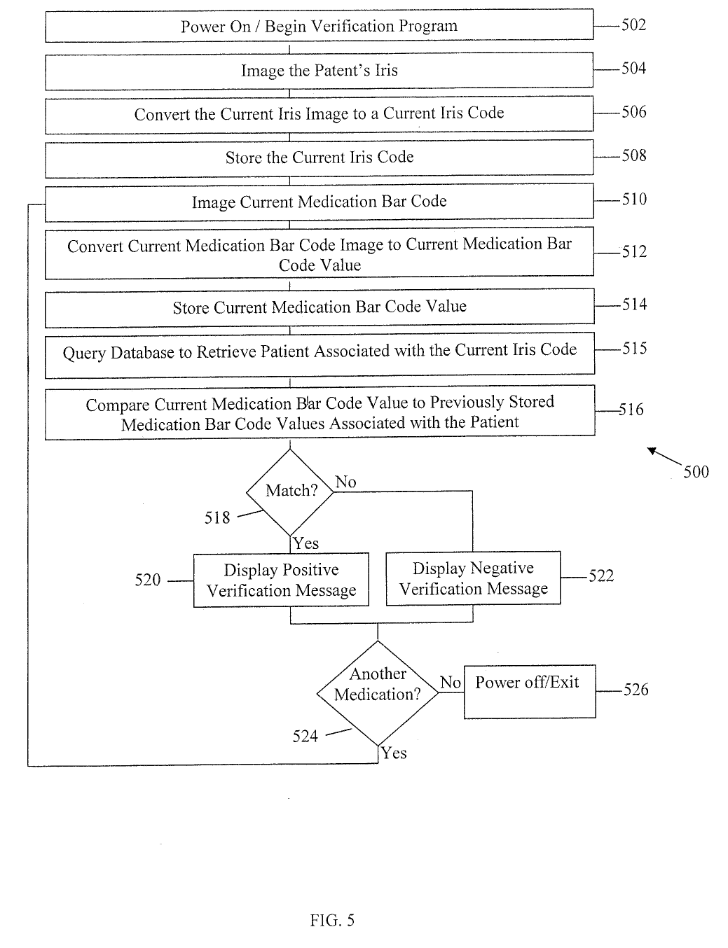

In the embodiment in which a biometric medication administration system is used for patient enrollment, the database can be stored in a local data storage means and the same biometric medication administration system is also used for associating a medication with a patient 400 as described below with respect to FIG. 4 and administering a medication to a patient 500 as described below with respect to FIG. 5. However, in a preferred embodiment, the database is stored in a network-accessible data storage device/memory optionally located in a host and/or remote computer 136 such that an iris recognition device and/or at least one biometric medication administration system is able to access the database over the network and through a network interface in order to store and retrieve patient information.

If a medical facility maintains the convention of issuing a wristband containing a bar code to a patient as part of the patient enrollment process, the bar code value can also be stored in the database as an attribute in the record representing the patient.

Referring to FIG. 4, a block diagram depicting the principal steps of the process of associating a medication with a patient 400 is shown. The process of associating a medication with a patient 400 involves preparing the medication 402, which is typically performed by a pharmacist, and creating a medication bar code associated with the medication 404. Generally, a pharmacist fills a patient's prescription and prints and attaches a bar code to the medication container. After the bar code is created at step 404 the bar code value is associated with the patient in the database 406. Since each medication is prescribed for only one patient, the medication may be an attribute in the record associated with the patient. Alternatively or in combination, a medication table can be stored in the database and a unique patient identifier, previously added to the database during the enrollment process as part of the patient identification information, is used as an index or a key and is also stored in the medication table. Also in this embodiment, the medication table can contain attributes such as time and/or frequency of administration, dosage, and means of administration, among others. Accordingly, at the end of the associating process for each medication 408, the bar code value of the bar code printed 408 and attached 410 to the medication is associated with the patient in the database.

Referring to FIG. 5, a block diagram depicting the principal steps of the process of administering a medication to a patient 500 is shown. The administering process typically occurs at the patient's bedside and the steps of the process 500 will be described as performed by a health care professional using the biometric medication administration system of the present invention and as described above in relation to FIGS. 1-2. Accordingly, the system is initially powered on at step 502, optionally by the user depressing the power button, and a verification program 125 is retrieved by the processor 116 from the data storage means 122. The verification program 125 can be a set of program instructions stored in the data storage means 122 that, when implemented by a processor 116, facilitate the verification of a medication administration 500 by providing information to the user through the display 202 and receiving information from the user through one or more user interface devices 204.

Accordingly, the verification program 125 can cause the display 202 to prompt the user to press ascan/capture button 206, or otherwise interact with the system, so as to image the patient's iris 504 and, optionally, store the current iris image in local or remote data storage means 122 subsequent to any image processing such any necessary analog to digital conversion. Next at step 503, the verification program 125 causes the processor 116 to retrieve the program instructions from the iris decode module 124 and implement the program instructions so as to convert the iris image to a current iris code. The verification program 125 then causes the processor 116 to store the current iris code in local or remote data storage means 508.

Next, and still prior to dispensing the medication, the verification program 125 can cause the display 202 to prompt the user to press a scan/capture button 206, or otherwise interact with the system, so as to image the current medication bar code 510 and, optionally, store the current medication bar code image in local or remote data storage means subsequent to any image processing such as analog to digital conversion. Next, the verification program 125 causes the processor 116 to retrieve the program instructions from the bar code decode module 126 and implement the program instructions an as to convert the medication bar code image to a current medication bar code value 512. The verification program 125 then causes the processor 116 to store the current medication bar code value in local or remote data storage means 514.

Subsequent to current iris code and current medication bar code conversion at steps 506 and 512, respectively, in one embodiment, the verification program 125 proceeds to query the database to retrieve the patient record associated with the current iris code 515. Next, at step 516, the verification program compares the current medication bar code value to the previously stored medication bar code value associated with the patient to determine if there is a match 518.

If the current medication bar code value matches a medication bar code value previously stored as associated with the patient (see step 406 described above), the verification program 125 causes a positive verification message to be communicated to the health care professional in the form of a text or graphic display output and/or an audible tone or message or any other message indicating a positive verification 520. In one embodiment, subsequent to a positive verification message, the verification program automatically removes the medication bar code value's association with the patient in the database. Accordingly, the health care professional can administer the medication and feel confident that the correct patient has been identified as the patient appropriate for administration of the specific medication.

In another embodiment, prior to communication of a positive verification message 520 but after verifying patient identify and medication type, the verification program can query the database to retrieve the record associated with the medication to retrieve at least one relevant attribute stored in the database such as dosage, administration time/frequency, or means of administration. Accordingly, the system can display a question as to dosage, administration time or intended means of administration causing the health care professional to answer the question or at least see the information thereby reducing the potential for error. Should the health car professional confirm that the display has been read/received, a positive verification message can then be communicated.

In another embodiment, also prior to communication of a positive verification message 520 but after verifying patient identify and medication type, the verification program can query the database to retrieve both the record associated with the medication and the record associated with the patient and compare the blood type attribute associated with the medication to the blood type attribute associated with the patient for a match. Assuming the medication has been entered into the database as intended for patients having a blood type matching that of the current patient, the system can then cause a positive verification message to be communicated.

In yet another embodiment, also prior to communication of a positive verification message 520 but after verifying patient identify and medication type, the verification program can query the database to retrieve the record associated with the medication and compare the previously entered time for administration to an internal clock and/or the previously entered last time the medication was administered to the patient. Assuming the time for administration is appropriate, the system can then cause a positive verification message to be communicated.

If no matching medication bar code exists either because the medication having the current medication bar code was not for administration to the patient and/or because no patient having a matching enrollment iris code was enrolled in the medical facility, the verification program 125 causes a negative verification message to be communicated to the health care professional in the form of a text or graphic display output and/or an audible tone or message or any other message indicating a negative verification 522. Optionally, the verification program 125 can be configured to indicate to the health care professional, by way of a display method or otherwise, the reason for the negative verification. Accordingly, the health care professional can be made aware that administering the specific medication to the patient may be an error and that further investigation should be pursued prior to administration.

In another embodiment, the verification program 125 queries the database to retrieve the patient record associated with the current medication bar code value instead of the current iris code. Assuming a unique bar code value for each prepared medication, there is a one-to-one relationship between iris codes and medication bar code values. Accordingly, in this embodiment, at step 516 of FIG. 5, the verification program 125 compares the current iris code to the previously stored enrollment iris code associated with the patient to determine if there is a match. Other permutations are also possible within the scope of the invention.

In one embodiment where a conventional wristband containing a bar code is issued to a patient upon enrollment the process can further include the verification program 125 further causing the display 202 to prompt the user to press a scan/capture button 206, or otherwise interact with the system, so as to image the patient's wristband bar code and, optionally, store the current wristband bar code image in local or remote data storage means subsequent to any image processing such as analog to digital conversion. Next, the verification program 125 causes the processor to retrieve the program instructions from the bar code decode module 126 and implement the program instructions so as to convert the wristband bar code image to a current wristband bar code value. The verification program 125 then causes the processor 116 to store the current wristband bar code value in local or remote data storage means. Accordingly, in this embodiment, the step 516 of comparing the current medication bar code value to the previously stored medication bar code value associated with the patient further includes comparing the current wristband bar code value to the previously stored wristband bar code value associated with the patient to determine whether there is a match.

Once a positive or negative verification message is displayed at steps 520 or 522, respectively, the verification program 125 can end/exit and/or cause the system to power off or display a message asking the health care professional if another medication is to be administered to the patient at this time 524. In the latter embodiment, the health care professional engages the keypad 204 or otherwise communicates to the system that either another medication bar code is to be read in which case the verification program proceeds to step 510 of FIG. 5 or that no other medication administration will be attempted at this time causing the verification program 125 to end and/or the system to power off 526.

It should be noted that in one embodiment wherein the processor is configured to control the iris image capture process such that successive iris images are captured, one using light in the near-infrared range and one using light in the visible range, as described above, the step of imaging 504 requires two image captures, the step of converting 506 requires two iris code conversions, the step of storing 508 requires storing two current iris codes, and the step of querying 515 can require querying the database to retrieve a patient record associated with either or both current iris codes. Since matching iris codes acquired from images captured using near-infrared light and visible light can result in reduced effectiveness and increased error rate, this embodiment allows for the administration process 500 to proceed with increased effectiveness irrespective of whether only near-infrared or only visible light was used to image the patient's iris at step 304 of the enrollment process 300.

In another embodiment in which the processor is configured to control the iris image capture process such that successive iris images are captured, one using light in the near-infrared range and one using light in the visible range, as described above, and the biometric medication administration system of the present invention is used in the enrollment process 300, the step of imaging 304 of the enrollment process 300 requires two image captures, the step of converting 306 requires two iris code conversions, and the step of associating 308 requires associating both enrollment iris codes with the patient in the database. In this embodiment, the administration process 500 can proceed with increased effectiveness irrespective of whether only near-infrared or only visible light is used to image the patient's iris at step 504 of administration process 500.

In one embodiment, upon discharge from the medical facility, the patient is removed from the database such that the patient record is deleted requiring the enrollment process to repeat should the person be admitted to the medical facility as a patient in the future. In another embodiment, the patient record contains an attribute indicating whether the patient is active or inactive such that upon discharge from the medical facility the patient record is labeled as inactive. Accordingly, in this embodiment, when the database is queried at step 515 of FIG. 5, only those records indicating active patients are available for retrieval.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A method of accurately administering medication to a patient comprising the steps of:
enrolling the patient including capturing an enrollment iris image, converting the enrollment iris image into an enrollment iris code, and associating the enrollment iris code with the patient in a database;
associating a medication with a patient including associating a medication bar code value associated with the medication bar code with the patient in the database; and
administering a medication to the patient including capturing a current iris image, converting the current iris image into a current iris code, capturing a current medication bar code image of the bar code associated with the medication, converting the current medication bar code image into a current medication bar code value, querying the database for any patient having a previously stored enrollment iris code matching the current iris code and comparing each previously stored medication bar code value associated with the patient with the current medication bar code value.

2. The method of claim 1 wherein the step of enrolling further includes creating a patient record in a database, storing the enrollment iris code in the patient record, and storing at least one personal identification information in the record.

3. The method of claim 1 wherein the step of associating further includes storing a bar code value associated with a medication in the patient record.

4. The method of claim 1 wherein the step of administering further includes querying the database for a patient record having an enrollment iris code matching the current iris code and comparing any medication bar code value associated with the patient record with the current medication bar code value.

5. The method of claim 1 wherein the step of enrollment further includes associating a wristband with a patient including associating a wristband bar code value associated with the wristband bar code with the patient in the database.

6. The method of claim 1 wherein the administering step further includes the steps of capturing a current wristband bar code image, converting the current wrist band bar code image into a current wrist band bar code value and wherein the querying step further includes comparing the current wristband bar code value to the previously stored wristband bar code value associated with the patient to determine whether there is a match.

7. The method of claim 1 further including the steps of receiving a positive verification message if any previously stored medication bar code value associated with the patient matches the current medication bar code value, administering the medication to the patient and updating the database to reflect that the medication has been administered to the patient.

8. The method of claim 1 further including the steps of receiving a negative verification message if no previously stored medication bar code value associated with the patient matches the current medication bar code value, the negative verification message indicating whether no patient exists having a matching enrollment iris code or no matching medication bar code value matches the current medication bar code value for the patient.

9. The method of claim 1 further including updating the database to reflect the inactivity of the patient upon discharge from the medical facility.

10. The method of claim 1 wherein the database is a relational database and wherein the querying step further includes retrieving a patient record if any previously stored enrollment iris code matches the current iris code.

11. A method of accurately administering medication to a patient comprising the steps of:
enrolling the patient including capturing an enrollment iris image, converting the enrollment iris image into an enrollment iris code, and associating the enrollment iris code with the patient in a database;
associating a medication with a patient including associating a medication bar code value associated with the medication bar code with the patient in the database; and
administering a medication to the patient including capturing a current iris image, converting the current iris image into a current iris code, capturing a current medication bar code image of the bar code associated with the medication, converting the current medication bar code image into a current medication bar code value, querying the database for any patient having a previously stored medication bar code value matching the current medication bar code value and comparing each previously stored enrollment iris code associated with the patient with the current iris code.

12. A method of accurately administering a medication to a patient comprising the steps of:
capturing a current iris image;
converting the current iris image into a current iris code;
capturing a current image of a bar code associated with the medicine;
converting the current medication bar code image into a current medication bar code value;
querying a database for any patient having a previously stored enrollment iris code matching the current iris code; and
comparing each previously stored medication bar code value associated with the patient with the current medication bar code value.

13. A method of accurately administering a medication to a patient comprising the steps of:
capturing a current iris image;
converting the current iris image into a current iris code;
capturing a current image of a bar code associated with the medication;
converting the current medication bar code image into a current medication bar code value;
querying a database for any patient having a previously stored medication bar code value matching the current medication bar code value; and
comparing each previously stored enrollment iris code associated with the patient with the current iris code.

14. A biometric medication administration apparatus for accurately administering a medication to a patient, comprising:
a reader housing;
an imaging assembly disposed in the housing, the imaging assembly including imaging optics and an image sensor;
an illumination assembly disposed in the housing, the illumination assembly including illumination optics and at least one light source;
data storage means configured to store an iris decode module and a bar code decode module;
at least one processor disposed in the housing, the processor being in communication with the imaging assembly and the illumination assembly, the processor being adapted for receiving instructions from the data storage means, configuring the image sensor, receiving pixel data, processing pixel data according to the iris decode module and the bar code decode module and outputting pixel data to the memory interface; and
a system bus in communication with the data storage means, the user input interface and the processor.

15. The apparatus of claim 14 further including a network interface configured to send and receive data across a network, the network interface being in communication with the system bus, the network interface being selected from the group consisting of RS-232, RS-485, USB, Ethernet, Wi-Fi, Bluetooth, IrDA and Zigbee.

16. The apparatus of claim 14 further including:
at least one user input device;
at least one user input interface configured to communicate with the system bus and the user input device;
at least one display; and
at least one display interface in communication with the system bus and the display.

17. The apparatus of claim 14 wherein the iris decode module includes a set of program instructions configured to convert an image containing a iris to an iris code when implemented by the processor.

18. The apparatus of claim 14 wherein the bar code decode module includes a set of program instructions configured to convert an image having a bar code to a bar code value when implemented by the processor.

19. The apparatus of claim 14 wherein the at least one light source includes at least one LED configured to emit light having a wavelength in the near-infrared range and at least one LED configured to emit light having a wavelength in the visible range.

20. A method of accurately administering a medication to a patient comprising the steps of:
capturing a current iris image;
converting the current iris image into a current iris code;
capturing a current image of a bar code associated with the medicine;
converting the current medication bar code image into a current medication bar code value;
querying a database to verify at least one of the patient identity, the administration time, the medication dosage, the patient blood type, the intended means of administration, and the medication type.
